(19) United States
(12) Patent Application Publication
(10) Pub. No.: US 2004/0027316 A1
(43) Pub. Date: Feb. 12, 2004

(54) Method and apparatus for driving plasma display panel

(75) Inventors: Seong Ho Kang, Buk-ku (KR); Sang Jin Yun, Pohang-shi (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/632,988

(22) Filed: Aug. 4, 2003

(30) Foreign Application Priority Data
Aug. 6, 2002 (KR) P2002-46409

(51) Int. Cl. G09G 3/28

(52) U.S. Cl. 345/60

(57) ABSTRACT

A method and apparatus of driving a plasma display panel that is adaptive for making a stable operation at a low temperature. In the method, a first driving waveform is applied to sub-fields at a temperature more than a low temperature. A second driving waveform different from the first driving waveform is supplied to the sub-fields at the low temperature.

### BACKGROUND OF THE INVENTION

1. Field of the Invention

This invention relates to a plasma display panel, and more particularly to a method and apparatus of driving a plasma display panel that is adaptive for making a stable operation at a low temperature.

2. Description of the Related Art

Generally, a plasma display panel (PDP) excites and radiates a phosphorus material using an ultraviolet ray generated upon discharge of an inactive mixture gas such as He+Xe, Ne+Xe or He+Ne+Xe, to thereby display a picture. Such a PDP is easy to be made into a thin-film and large-dimension type. Moreover, the PDP provides a very improved picture quality owing to a recent technical development.

Referring to FIG. 1, a discharge cell of a conventional three-electrode, AC surface-discharge PDP includes a scan electrode 30Y and a common sustain electrode 30Z provided on an upper substrate 10, and an address electrode 20X provided on a lower substrate 18. Each of the scan electrode 30Y and the common sustain electrode 30Z includes transparent electrodes 12Y and 12Z, and metal bus electrodes 13Y and 13Z having smaller line widths than the transparent electrodes 12Y and 12Z and provided at one edge of the transparent electrodes 12Y and 12Z.

The transparent electrodes 12Y and 12Z are usually formed from indium-tin-oxide (ITO) on the upper substrate 10. The metal bus electrodes 13Y and 13Z are usually formed from a metal such as chrome (Cr), etc. on the transparent electrodes 12Y and 12Z to thereby reduce a voltage drop caused by the transparent electrodes 12Y and 12Z having a high resistance.

On the upper substrate 10 provided, in parallel, with the scan electrode 30Y and the common sustain electrode 30Z, an upper dielectric layer 14 and an MgO protective film 16 are disposed. Wall charges generated upon plasma discharge are accumulated onto the upper dielectric layer 14. The protective film 16 prevents a damage of the upper dielectric layer 14 caused by a sputtering during the plasma discharge and improves the emission efficiency of secondary electrons. This protective film 16 is usually made from magnesium oxide (MgO).

A lower dielectric layer 22 and barrier ribs 24 are formed on the lower substrate 18 provided with the address electrode 20X. The surfaces of the lower dielectric layer 22 and the barrier ribs 24 are coated with a phosphorous material 26. The address electrode 20X is formed in a direction crossing the scan electrode 30Y and the sustain electrode 30Z. The barrier rib 24 is formed in parallel to the address electrode 20X to thereby prevent an ultraviolet ray and a visible light generated by a discharge from being leaked to the adjacent discharge cells. The phosphorous material 26 is excited by an ultraviolet ray generated during the plasma discharge to generate any one of red, green and blue visible light rays. An inactive mixture gas for a gas discharge is injected into a discharge space defined between the upper and lower substrate 10 and 18 and the barrier rib 24.

Such a PDP makes a time-divisional driving of one frame, which is divided into various sub-fields having a different emission frequency, so as to realize gray levels of a picture. Each sub-field is again divided into an initialization period for initializing the entire field, an address period for selecting a scan line and selecting the cell from the selected scan line and a sustain period for expressing gray levels depending on the discharge frequency. Herein, the initialization period is again divided into a set-up interval supplied with a rising ramp waveform and a set-down interval supplied with a falling ramp waveform.

For instance, when it is intended to display a picture of 256 gray levels, a frame interval equal to 1/60 second (i.e. 16.67 msec) is divided into 8 sub-fields SF1 to SF8 as shown in FIG. 2. Each of the 8 sub-field SF1 to SF8 is divided into an initialization period, an address period and a sustain period as mentioned above. Herein, the initialization period and the address period of each subfield are equal for each sub-field, whereas the sustain period and the number of sustain pulses assigned thereto are increased at a ratio of 2ⁿ (wherein n=0, 1, 2, 3, 4, 5, 6 and 7) at each sub-field.

FIG. 3 shows a driving waveform of the PDP applied to two sub-fields. Herein, Y represents the scan electrode; Z does the common sustain electrode; and X does the address electrode.

Referring to FIG. 3, the PDP is divided into an initialization period for initializing the full field, an address period for selecting a cell, and a sustain period for sustaining a discharge of the selected cell for its driving.

In the initialization period, a rising ramp waveform Ramp-up is simultaneously applied all the scan electrodes Y in a set-up interval. This rising ramp waveform Ramp-up causes a weak discharge within cells the full field to generate wall charges within the cells. In the set-down interval, after the rising ramp waveform Ramp-up was supplied, a falling ramp waveform Ramp-down falling from a positive voltage lower than a peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage Zdc having a sustain voltage level Vs is applied to the common sustain electrodes Z during the set-down interval and the address period.

In the sustain period, a sustaining pulse sus is alternately applied to the scan electrodes Y and the common sustain electrodes Z. Then, a wall voltage within the cell selected by the address discharge is added to the sustain pulse sus to thereby generate a sustain discharge taking a surface-discharge type between the scan electrode Y and the common sustain electrode Z whenever each sustain pulse sus is applied.

Finally, after the sustain discharge was finished, a erasing ramp waveform erase having a small pulse width is applied to the common sustain electrode Z to thereby erase wall charges left within the cells.

However, such a conventional PDP has a problem in that a contrast is deteriorated due to a light generated in the initialization period. More specifically, the rising ramp waveform Ramp-up supplied in the initialization period causes a discharge between the scan electrode Y and the common sustain electrode and between the scan electrode Y and the address electrode X, thereby forming negative wall charges at the scan electrode Y and forming positive wall charges at the common sustain electrode Z.

At the result of an experiment, a discharge between the scan electrode Y and the common sustain electrode Z is generated at a lower voltage than a discharge between the scan electrode Y and the address electrode Z. The discharge occurring between the scan electrode Y and the common sustain electrode Z allows an emission amount of a light progressing toward an observer to be larger than an amount of a light generated by the discharge between the scan electrode Y and the address electrode X. Since this increases an emission amount of a light in the initialization period which is a non-display period, a contrast property is deteriorated.

Accordingly, in the prior art, there has been suggested a driving method as shown in FIG. 5 in order to improve a contrast property of the PDP.

FIG. 5 shows another conventional method of driving a plasma display panel.

Referring to FIG. 5, said another conventional method of driving the PDP is divided into an initialization period for initializing the full field, an address period for selecting a cell, and a sustain period for sustaining a discharge of the selected cell for its driving.

In the initialization period, a rising ramp waveform Ramp-up is simultaneously applied all the scan electrodes Y in a set-up interval. This rising ramp waveform Ramp-up causes a weak discharge within cells the full field to generate wall charges within the cells. In the set-down interval, after the rising ramp waveform Ramp-up risen into a peak voltage Vr, the peak voltage Vr is applied to the scan electrodes Y during a certain time. If the peak voltage Vr of the rising ramp waveform Ramp-up is kept during a certain time, then wall charges formed in the discharge cell is intensified.

In the first half of the set-up interval, a ground voltage is applied to the common sustain electrodes Z. On the other hand, in the second half of the set-up interval, the common sustain electrodes Z are floated. In the first half of the set-up interval when the common sustain electrodes are supplied with a ground voltage, a discharge is generated between the scan electrodes Y and the common sustain electrodes Z to thereby form wall charges within the discharge cell. In the second half of the set-up interval, a discharge is not generated between the scan electrodes Y and the common sustain electrodes Z. In other words, in the second half of the set-up interval, a discharge is generated only between the scan electrodes Y and the address electrodes X.

In other words, in the second half of the set-up period, the common sustain electrodes Z are floated, thereby preventing a surface discharge from occurring between the scan electrodes Y and the common sustain electrodes Y.

Accordingly, according to another conventional example, a brightness in the initialization period is lowered and hence a contrast is enhanced. Herein, if the common sustain electrodes Z are floated, then an amount of wall charges formed in the set-up interval becomes smaller than the method of driving the PDP as shown in FIG. 3.

Meanwhile, in the second half of the set-up interval when the common sustain electrodes Z keeps a floating state, a certain voltage is derived into the common sustain electrodes Z. In other words, a certain voltage is derived into the common sustain electrodes Z by a time interval when the rising ramp waveform Ramp-up and the peak voltage Vr applied to the scan electrodes Y in the second half of the set-up interval is kept.

In the set-down interval, the falling ramp waveform Ramp-down is applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage Zdc having a sustain voltage level Vs is applied to the common sustain electrodes Z during the set-down interval and the address period.

In the sustain period, a sustaining pulse sus is alternately applied to the scan electrodes Y and the common sustain electrodes Z. Then, a wall voltage within the cell selected by the address discharge is added to the sustain pulse sus to thereby generate a sustain discharge taking a surface-discharge type between the scan electrode Y and the common sustain electrode Z whenever each sustain pulse sus is applied.

Finally, after the sustain discharge was finished, an erasing ramp waveform erase having a small pulse width is applied to the common sustain electrode Z to thereby erase wall charges left within the cells.

However, if the conventional PDP driven as shown in FIG. 5 is operated at a low temperature (i.e., approximately 20° C. to −50° C.), then a brightness misfire occurs. In other words, as the result of a low-temperature operation characteristic, the PDP driven in the manner as shown in FIG. 5 causes a brightness misfire at a plurality of discharge cells. It has been supposed that such a brightness misfire occurs because a motion of particles becomes dull at a low temperature.

More specifically, if a motion of particles becomes dull at a low temperature, then an erasure discharge caused by the erasing ramp waveform erase may be not normally generated. Wall charges formed in the scan electrode Y and the common sustain electrode Z is not erased from cells in which such an erasure discharge has not been normally generated.

Thereafter, in the set-up interval, a positive rising ramp waveform Ramp-up is applied to the scan electrode Y. At this time, since negative wall charges has been formed at the scan electrode Y, that is, since the polarity of a voltage applied to the scan electrode Y is contrary to that of wall charges formed in the scan electrode Y, a normal discharge is not generated in the set-up interval. Thus, a stable discharge is not generated in the set-down interval following the set-up interval. If a normal discharge does not occur in the initialization period, then wall charges having an erasing failure in the erasure period make an affect to the address period and the sustain period. In other words, a strong discharge taking an undesired brightness point shape is generated in the sustain period due to wall charges formed excessively in the discharge cells.

Such a brightness point misfire is mainly generated from the discharge cells provided with blue and green phosphorous materials. More specifically, since the blue and green phosphorous materials has a discharge initiation voltage set to be higher than a red phosphorous material by approximately 20V to 30V, a normal discharge is not generated in the initialization period and hence a brightness misfire occurs.

### SUMMARY OF THE INVENTION

Accordingly, it is an object of the present invention to provide a method and apparatus of driving a plasma display panel that is adaptive for making a stable operation at a low temperature.

In order to achieve these and other objects of the invention, a method of driving a plasma display panel according to one aspect of the present invention, having one frame divided into a plurality of sub-fields for its driving, includes the steps of applying a first driving waveform to said sub-fields at a temperature more than a low temperature; and applying a second driving waveform different from the first driving waveform to said subfields at the low temperature.

In the method, each of said sub-fields includes an initialization period, which is divided into a set-up interval for forming wall charges at a discharge cell and a set-down interval for erasing a portion of the wall charges formed in the set-up interval.

Said first and second driving waveforms are set such that the waveforms applied in the set-up interval are different from each other while the waveforms applied in the other interval are identical to each other.

The method further includes the steps of applying a rising ramp waveform to a scan electrode provided at each discharge cell during the set-up interval when said first driving waveform is supplied; applying a ground voltage to a common sustain electrode provided, in parallel with the scan electrode, at each discharge cell in the first half of the set-up interval; and floating the sustain electrode in the second half of the set-up interval.

The method further includes the steps of applying a rising ramp waveform to a scan electrode provided at each discharge cell during the set-up interval when said second driving waveform is supplied; and applying a ground voltage to a common sustain electrode provided, in parallel with the scan electrode, at each discharge cell.

Herein, said low temperature is 20° C. to −50° C.

A method of driving a plasma display panel according to another aspect of the present invention, in which an initialization period included in each sub-field is divided into a set-up interval and a set-down interval for its driving, includes the steps of displaying a picture on the panel; sensing a driving temperature of the panel; and setting a driving waveform to be applied in the set-up interval in correspondence with said driving temperature of the panel.

Herein, a driving waveform supplied when said driving temperature of the panel is a low temperature is set differently from a driving waveform supplied when said driving temperature of the panel is more than the low temperature.

The method further includes the steps of applying a rising ramp waveform to a scan electrode provided at each discharge cell during the set-up interval when said driving temperature of the panel is said low temperature; and applying a ground voltage to a common sustain electrode provided, in parallel with the scan electrode, at each discharge cell.

The method further includes the steps of applying a rising ramp waveform to a scan electrode provided at each discharge cell during the set-up interval when said driving temperature of the panel is a temperature more than said low temperature; applying a ground voltage to a common sustain electrode provided, in parallel with the scan electrode, at each discharge cell in the first half of the set-up interval; and floating the sustain electrode in the second half of the set-up interval.

A driving apparatus for a plasma display panel according to still another aspect of the present invention, in which an initialization period included in each sub-field is divided into a set-up interval and a set-down interval for its driving, includes a temperature sensor for sensing a driving temperature of the panel; a switching device provided between a plurality of common sustain electrodes provided at the panel and a ground voltage source; and a timing controller for controlling a turning-on and a turning-off of the switching device in correspondence with a temperature inputted from the temperature sensor.

In the driving apparatus, said timing controller differently controls said turning-on and said turning-off of the switching device when a driving temperature inputted from the temperature sensor is a low temperature and when a driving temperature inputted from the temperature sensor is a temperature more than the low temperature.

Herein, said timing controller turns on the switching device in the first half of the set-up interval while turning off the switching device in the second half of the set-up interval to float the common sustain electrode when a driving temperature inputted from the temperature sensor is more than said low temperature.

Otherwise, said timing controller turns on the switching device during the set-up interval when a driving temperature inputted from the temperature sensor is said low temperature.

The driving apparatus further includes a sustain driver for driving the common sustain electrode; a scan driver for driving a plurality of scan electrodes provided in parallel with the common sustain electrode; and a data driver for driving a plurality of address electrode provided in a direction crossing the common sustain electrode, wherein said timing controller controls the sustain driver, and the scan driver and the data driver.

A driving apparatus for a plasma display panel according to still another aspect of the present invention, in which an initialization period included in each sub-field is divided into a set-up interval and a set-down interval for its driving, includes a temperature sensor for sensing a driving temperature of the panel; a switching device provided between a plurality of common sustain electrodes provided at the panel and a ground voltage source; and a switch controller for controlling a turning-on and a turning-off of the switching device in correspondence with a temperature inputted from the temperature sensor.

In the driving apparatus, said switch controller differently controls said turning-on and said turning-off of the switching device when a driving temperature inputted from the temperature sensor is a low temperature and when a driving temperature inputted from the temperature sensor is more than the low temperature.

Herein, said switch controller turns on the switching device in the first half of the set-up interval while turning off the switching device in the second half of the set-up interval to float the common sustain electrode when a driving temperature inputted from the temperature sensor is more than said low temperature.

Otherwise, said switch controller turns on the switching device during the set-up interval when a driving temperature inputted from the temperature sensor is said low temperature.

### BRIEF DESCRIPTION OF THE DRAWINGS

These and other objects of the invention will be apparent from the following detailed description of the embodiments of the present invention with reference to the accompanying drawings, in which:

FIG. 1 is a perspective view showing a discharge cell structure of a conventional three-electrode, AC surface-discharge plasma display panel;

FIG. 2 illustrates one frame in the conventional AC surface-discharge plasma display panel;

FIG. 3 is a waveform diagram showing a driving waveform supplied to the electrodes during the sub-field shown in FIG. 2;

FIG. 4 depicts wall charges formed at the electrodes in the initialization period;

FIG. 5 is a waveform diagram for explaining another conventional method of driving the plasma display panel;

FIG. 6 depicts wall charges having been formed at the cells in which an erasure discharge is not normally generated at a low temperature;

FIG. 7 is a waveform diagram for explaining a method of driving a plasma display panel according to an embodiment of the present invention;

FIG. 8A and FIG. 8B depict voltage differences of driving waveforms applied at a low temperature and at a temperature more than the low temperature in the set-up interval;

FIG. 9 is a block diagram showing a configuration of a driving apparatus for a plasma display panel according to an embodiment of the present invention;

FIG. 10 is a block diagram showing a configuration of a driving apparatus for a plasma display panel according to another embodiment of the present invention; and

FIG. 11 is a waveform diagram of control signals applied to switching devices shown in FIG. 9 and FIG. 10.

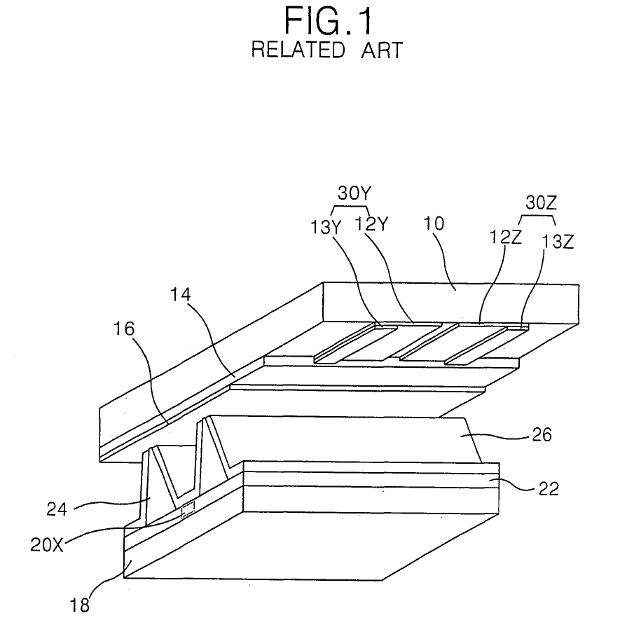

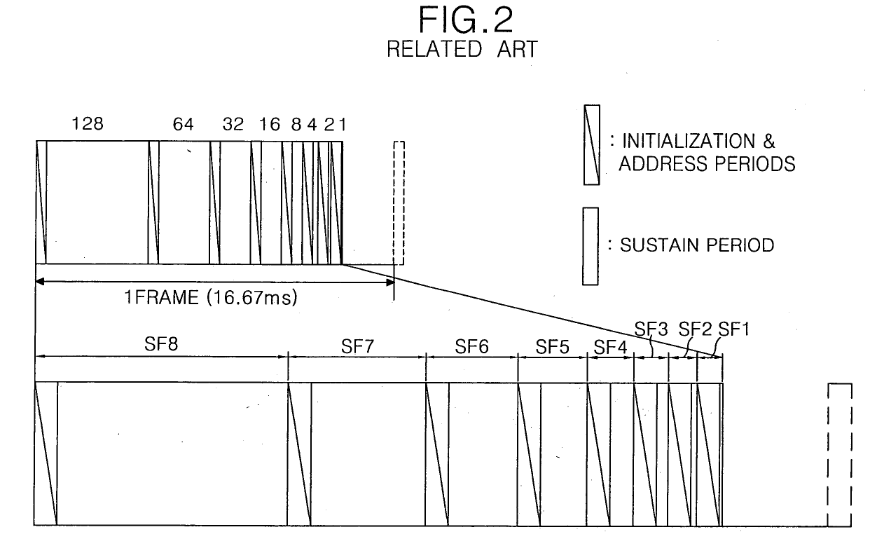

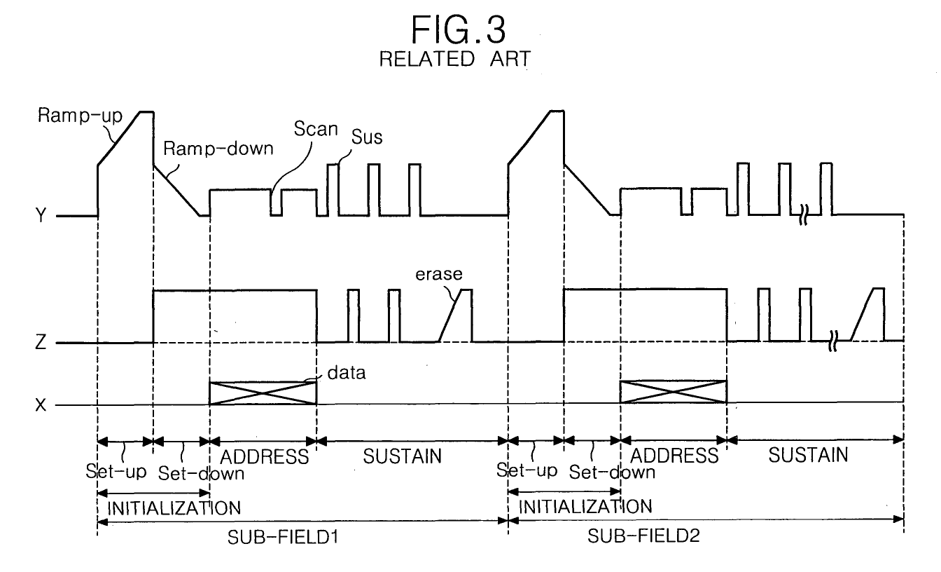

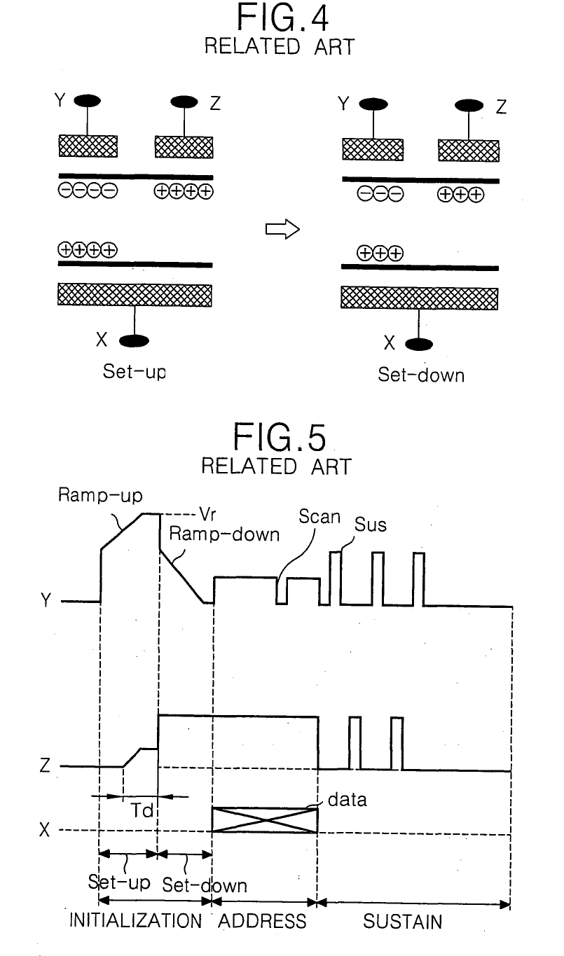

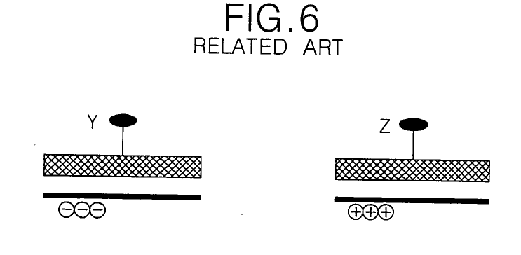

### DETAILED DESCRIPTION OF THE PREFERRED EMBODIMENT

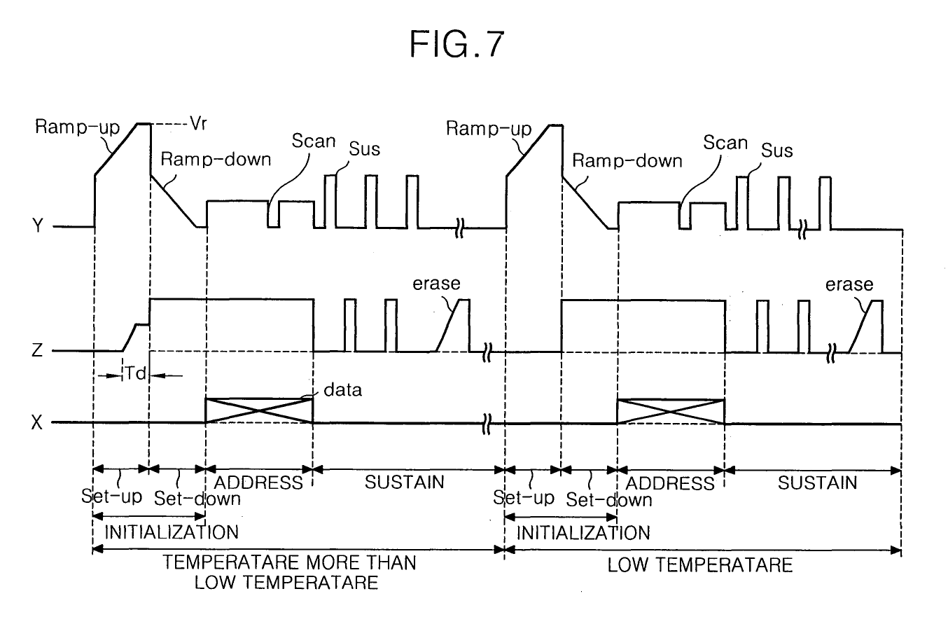

FIG. 7 shows a method of driving a plasma display panel (PDP) according to an embodiment of the present invention.

Referring to FIG. 7, in the PDP according to the embodiment of the present invention, a driving pulse applied at a low temperature (i.e., approximately 20° C. to −50° C.) is set to be different from a driving pulse applied at a temperature more than the low temperature.

First, when the PDP is driven at a temperature more than the low temperature, the PDP is divided into an initialization period for initializing the full field, an address period for selecting a cell, and a sustain period for sustaining a discharge of the selected cell for its driving.

In the initialization period, a rising ramp waveform Ramp-up is simultaneously applied all the scan electrodes Y in a set-up interval. This rising ramp waveform Ramp-up causes a weak discharge within cells the full field to generate wall charges within the cells. In the set-up interval, after the rising ramp waveform Ramp-up risen into a peak voltage Vr, the peak voltage Vr is applied to the scan electrodes Y during a certain time. If the peak voltage Vr of the rising ramp waveform Ramp-up is kept during a certain time, then wall charges formed in the discharge cell is intensified.

In the first half of the set-up interval, a ground voltage is applied to the common sustain electrodes Z. On the other hand, in the second half of the set-up interval, the common sustain electrodes Z are floated. In the first half of the set-up interval when the common sustain electrodes are supplied with a ground voltage, a discharge is generated between the scan electrodes Y and the common sustain electrodes Z to thereby form wall charges within the discharge cell. In the second half of the set-up interval, a discharge is not generated between the scan electrodes Y and the common sustain electrodes Z. In other words, in the second half of the set-up interval, a discharge is generated only between the scan electrodes Y and the address electrodes X.

In other words, in the second half of the set-up period, the common sustain electrodes Z are floated at a temperature more than the low temperature, thereby preventing a surface discharge from occurring between the scan electrodes Y and the common sustain electrodes Y. Accordingly, in the embodiment of the present invention, a brightness in the initialization period can be lowered when the PDP is operated at a temperature more than the low temperature, thereby enhancing a contrast.

Meanwhile, in the second half of the set-up interval when the common sustain electrodes Z keeps a floating state, a certain voltage is derived into the common sustain electrodes Z. In other words, a certain voltage is derived into the common sustain electrodes Z by a time interval when the rising ramp waveform Ramp-up and the peak voltage Vr applied to the scan electrodes Y in the second half of the set-up interval is kept.

In the set-down interval, the falling ramp waveform Ramp-down is applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage Zdc having a sustain voltage level Vs is applied to the common sustain electrodes Z during the set-down interval and the address period.

In the sustain period, a sustaining pulse sus is alternately applied to the scan electrodes Y and the common sustain electrodes Z. Then, a wall voltage within the cell selected by the address discharge is added to the sustain pulse sus to thereby generate a sustain discharge taking a surface-discharge type between the scan electrode Y and the common sustain electrode Z whenever each sustain pulse sus is applied.

Finally, after the sustain discharge was finished, an erasing ramp waveform erase having a small pulse width is applied to the common sustain electrode Z to thereby erase wall charges left within the cells.

On the other hand, when the PDP is driven at a low temperature (i.e., approximately 20° C. to −50° C.), the PDP is divided into an initialization period for initializing the full field, an address period for selecting a cell, and a sustain period for sustaining a discharge of the selected cell for its driving.

In the initialization period, a rising ramp waveform Ramp-up is simultaneously applied all the scan electrodes Y in a set-up interval. This rising ramp waveform Ramp-up causes a weak discharge within cells the full field to generate wall charges within the cells. In the set-up interval, a ground voltage is applied to the common sustain electrode Z. In other words, when the PDP is driven at the low temperature, the common sustain electrode Z is not floated. If the common sustain electrode Z is not floated, then a high voltage difference is generated between the scan electrode Y and the common sustain electrode Z to thereby cause a stable discharge within the cell.

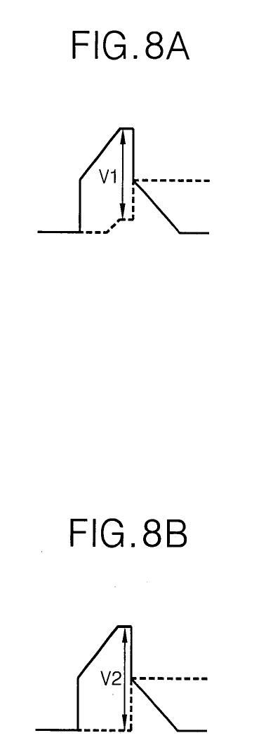

More specifically, in the second half of the set-up interval, the common sustain electrodes Z are floated at a temperature more than the low temperature. If the common sustain electrode Z is floated, then a voltage difference V1 is generated between the scan electrode Y and the common sustain electrode Z as shown in FIG. 8A. In FIG. 8A, the solid line represents a voltage applied to the scan electrode while the dotted line represents a voltage derived into the common sustain electrode Z.

On the other hand, in the second half of the set-up interval, the common sustain electrode Z is not floated in the low temperature. If the common sustain electrode Z is not floated, then a voltage difference V2 higher than the voltage V1 is generated between the scan electrode Y and the common sustain electrode Z as shown in FIG. 8B. Accordingly, a stable set-up discharge can be caused at the low temperature. In other words, in the embodiment of the present invention, the common sustain electrode Z is floated at a temperature more than the low temperature to thereby improve a contrast, and the common sustain electrode Z is not floated at the low temperature to thereby cause a stable set-up discharge.

In the set-down interval, after the rising ramp waveform Ramp-up was supplied, a falling ramp waveform Ramp-down falling a positive voltage lower than the peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage Zdc having a sustain voltage level Vs is applied to the common sustain electrodes Z during the set-down interval and the address period.

In the sustain period, a sustaining pulse sus is alternately applied to the scan electrodes Y and the common sustain electrodes Z. Then, a wall voltage within the cell selected by the address discharge is added to the sustain pulse sus to thereby generate a sustain discharge taking a surface-discharge type between the scan electrode Y and the common sustain electrode Z whenever each sustain pulse sus is applied.

Finally, after the sustain discharge was finished, an erasing ramp waveform erase having a small pulse width is applied to the common sustain electrode Z to thereby erase wall charges left within the cells.

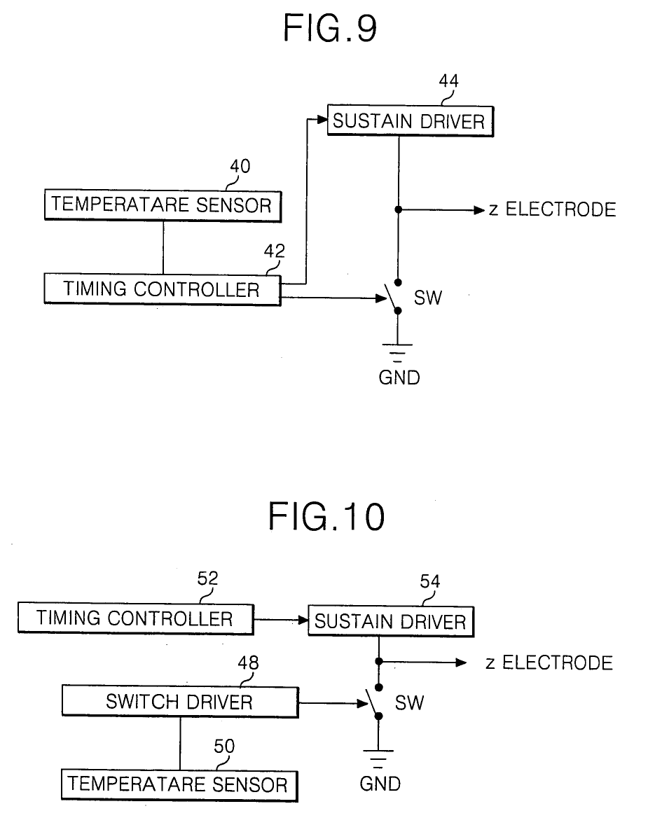

FIG. 9 shows a driving apparatus for the PDP for supplying the waveforms in FIG. 7.

Referring to FIG. 9, the driving apparatus includes a sustain driver 44 for applying a positive direct current voltage and a sustaining pulse to the common sustain electrodes Z, a temperature sensor 40 for sensing a driving temperature of the panel, a timing controller 42 for controlling the sustain driver 44, and a switching device SW provided between the common sustain electrodes Z and a ground voltage source GND.

The timing controller 42 receives vertical and horizontal synchronizing signals to generates timing control signals required for the sustain driver 44, and applies the timing control signals to the sustain driver 44. Such a timing controller 42 applies the timing control signals to the sustain driver 44 as well as a data driver for driving an address electrodes and a scan driver for driving scan electrodes (not shown). The timing controller 42 controls a turning-on and a turning-off of the switching device SW in correspondence with a driving temperature of the panel inputted from the temperature sensor 40.

The temperature sensor 40 senses the driving temperature of the panel to apply the control signals to the timing controller 42. The temperature sensor 40 generates different control signals when the panel is driven at a low temperature and when the panel is driven at a temperature more then the low temperature, and applies the control signals to the timing controller 42.

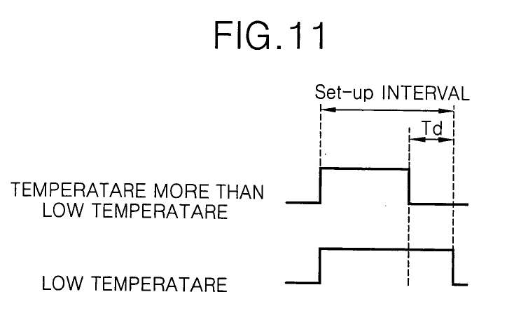

In operation, the temperature sensor 40 applies a first control signal to the timing controller 42 when the panel is driven at a temperature more than the lower temperature. The timing controller 42 having received the first control signal from the temperature sensor 40 applies a high-level control signal to the switching device SW in the first half of the set-up interval while applying a low-level control signal to the switching device SW in the second half of the set-up interval as shown in FIG. 11.

The switching device SW having received the high-level control signal from the timing controller 42 is turned on in the first half of the set-up interval to thereby applies a voltage of the ground voltage source GND to the common sustain electrode Z. On the other hand, the switching device SW having received the low-level control signal from the timing controller 42 is turned off in the second half of the set-up interval to float the common sustain electrode Z. Thus, the common sustain electrode Z is floated in the second half Td of the set-up interval as shown in FIG. 7 when the PDP is driven at a temperature more than the low temperature to thereby minimize an amount of light generated in the set-up interval.

On the other hand, the temperature sensor 40 applies the second timing signal to the timing controller 42 when the panel is driven at the low temperature. The timing controller 42 having received the second timing control signal from the temperature sensor 40 applies a high-level control signal to the switching device SW in the set-up interval as shown in FIG. 11.

The switching device SW having received the high-level control signal from the timing controller 42 is turned on during the set-up interval to thereby apply a voltage of the ground voltage source GND to the common sustain electrode Z. Thus, the common sustain electrode Z is supplied with a ground potential during the set-up interval as shown in FIG. 7 when the PDP is driven at the low temperature and hence generates a stable set-up discharge at the low temperature.

FIG. 10 shows a driving apparatus for the PDP according to another embodiment of the present invention.

Referring to FIG. 10, the driving apparatus includes a sustain driver 54 for applying a positive direct current voltage and a sustaining pulse to the common sustain electrodes Z, a temperature sensor 50 for sensing a driving temperature of the panel, a timing controller 52 for controlling the sustain driver 54, a switching device SW provided between the common sustain electrodes Z and a ground voltage source GND, and a switch controller 48 for controlling the switching device SW.

The timing controller 52 receives vertical and horizontal synchronizing signals to generates timing control signals required for the sustain driver 54, and applies the timing control signals to the sustain driver 54. Such a timing controller 52 applies the timing control signals to the sustain driver 54 as well as a data driver for driving an address electrodes and a scan driver for driving scan electrodes (not shown).

The temperature sensor 50 senses the driving temperature of the panel to apply the control signals to the switch controller 48. The temperature sensor 50 generates different control signals when the panel is driven at a low temperature and when the panel is driven at a temperature more then the low temperature, and applies the control signals to the switch controller 48. The switch controller 48 applies a high or low-level control signal to the switching device SW in correspondence with the control signal from the temperature sensor 50.

In operation, the temperature sensor 50 applies a first control signal to the switch controller 48 when the panel is driven at a temperature more than the lower temperature. The switch controller 48 having received the first control signal from the temperature sensor 50 applies a high-level control signal to the switching device SW in the first half of the set-up interval while applying a low-level control signal to the switching device SW in the second half Td of the set-up interval as shown in FIG. 11.

The switching device SW having received the high-level control signal from the switch controller 48 is turned on in the first half of the set-up interval to thereby applies a voltage of the ground voltage source GND to the common sustain electrode Z. On the other hand, the switching device SW having received the low-level control signal from the switch controller 48 is turned off in the second half of the set-up interval to float the common sustain electrode Z. Thus, the common sustain electrode Z is floated in the second half Td of the set-up interval as shown in FIG. 7 when the PDP is driven at a temperature more than the low temperature to thereby minimize an amount of light generated in the set-up interval.

On the other hand, the temperature sensor 50 applies the second timing signal to the switch controller 48 when the panel is driven at the low temperature. The switch controller 48 having received the second timing control signal from the temperature sensor 50 applies a high-level control signal to the switching device SW in the set-up interval as shown in FIG. 11.

The switching device SW having received the high-level control signal from the switch controller 48 is turned on during the set-up interval to thereby apply a voltage of the ground voltage source GND to the common sustain electrode Z. Thus, the common sustain electrode Z is supplied with a ground potential during the set-up interval as shown in FIG. 7 when the PDP is driven at the low temperature and hence generates a stable set-up discharge at the low temperature.

As described above, according to the present invention, wen the plasma display panel is driven at the low temperature, the common sustain electrode is not floated in the second half of the set-up interval, thereby causing a stable set-up discharge at the low temperature. Furthermore, when the plasma display panel is driven at a temperature more than the low temperature, the common sustain electrode is floated in the second half of the set-up interval, thereby improving a contrast.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A method of driving a plasma display panel having one frame divided into a plurality of sub-fields for its driving, comprising the steps of:
applying a first driving waveform to said sub-fields at a temperature more than a low temperature; and
applying a second driving waveform different from the first driving waveform to said sub-fields at the low temperature.

2. The method as claimed in claim 1, wherein each of said sub-fields includes an initialization period, which is divided into a set-up interval for forming wall charges at a discharge cell and a set-down interval for erasing a portion of the wall charges formed in the set-up interval.

3. The method as claimed in claim 2, wherein said first and second driving waveforms are set such that the waveforms applied in the set-up interval are different from each other while the waveforms applied in the other interval are identical to each other.

4. The method as claimed in claim 2, further comprising the steps of:
applying a rising ramp waveform to a scan electrode provided at each discharge cell during the set-up interval when said first driving waveform is supplied;
applying a ground voltage to a common sustain electrode provided, in parallel with the scan electrode, at each discharge cell in the first half of the set-up interval; and
floating the sustain electrode in the second half of the set-up interval.

5. The method as claimed in claim 2, further comprising the steps of:
applying a rising ramp waveform to a scan electrode provided at each discharge cell during the set-up interval when said second driving waveform is supplied; and
applying a ground voltage to a common sustain electrode provided, in parallel with the scan electrode, at each discharge cell.

6. The method as claimed in claim 2, wherein said low temperature is 20° C. to −50° C.

7. A method of driving a plasma display panel in which an initialization period included in each sub-field is divided into a set-up interval and a set-down interval for its driving, comprising the steps of:
displaying a picture on the panel;
sensing a driving temperature of the panel; and
setting a driving waveform to be applied in the set-up interval in correspondence with said driving temperature of the panel.

8. The method as claimed in claim 7, wherein a driving waveform supplied when said driving temperature of the panel is a low temperature is set differently from a driving waveform supplied when said driving temperature of the panel is more than the low temperature.

9. The method as claimed in claim 8, further comprising the steps of:
applying a rising ramp waveform to a scan electrode provided at each discharge cell during the set-up interval when said driving temperature of the panel is said low temperature; and
applying a ground voltage to a common sustain electrode provided, in parallel with the scan electrode, at each discharge cell.

10. The method as claimed in claim 8, further comprising the steps of:
applying a rising ramp waveform to a scan electrode provided at each discharge cell during the set-up interval when said driving temperature of the panel is a temperature more than said low temperature;
applying a ground voltage to a common sustain electrode provided, in parallel with the scan electrode, at each discharge cell in the first half of the set-up interval; and
floating the sustain electrode in the second half of the set-up interval.

11. A driving apparatus for a plasma display panel in which an initialization period included in each sub-field is divided into a set-up interval and a set-down interval for its driving, comprising:
a temperature sensor for sensing a driving temperature of the panel;
a switching device provided between a plurality of common sustain electrodes provided at the panel and a ground voltage source; and
a timing controller for controlling a turning-on and a turning-off of the switching device in correspondence with a temperature inputted from the temperature sensor.

12. The driving apparatus as claimed in claim 11, wherein said timing controller differently controls said turning-on and said turning-off of the switching device when a driving temperature inputted from the temperature sensor is a low temperature and when a driving temperature inputted from the temperature sensor is a temperature more than the low temperature.

13. The driving apparatus as claimed in claim 12, wherein said timing controller turns on the switching device in the first half of the set-up interval while turning off the switching device in the second half of the set-up interval to float the common sustain electrode when a driving temperature inputted from the temperature sensor is more than said low temperature.

14. The driving apparatus as claimed in claim 12, wherein said timing controller turns on the switching device during the set-up interval when a driving temperature inputted from the temperature sensor is said low temperature.

15. The driving apparatus as claimed in claim 11, further comprising:
a sustain driver for driving the common sustain electrode;
a scan driver for driving a plurality of scan electrodes provided in parallel with the common sustain electrode; and
a data driver for driving a plurality of address electrode provided in a direction crossing the common sustain electrode,
wherein said timing controller controls the sustain driver, and the scan driver and the data driver.

16. A driving apparatus for a plasma display panel in which an initialization period included in each sub-field is divided into a set-up interval and a set-down interval for its driving, comprising:
a temperature sensor for sensing a driving temperature of the panel;
a switching device provided between a plurality of common sustain electrodes provided at the panel and a ground voltage source; and
a switch controller for controlling a turning-on and a turning-off of the switching device in correspondence with a temperature inputted from the temperature sensor.

17. The driving apparatus as claimed in claim 16, wherein said switch controller differently controls said turning-on and said turning-off of the switching device when a driving temperature inputted from the temperature sensor is a low temperature and when a driving temperature inputted from the temperature sensor is more than the low temperature.

18. The driving apparatus as claimed in claim 17, wherein said switch controller turns on the switching device in the first half of the set-up interval while turning off the switching device in the second half of the set-up interval to float the common sustain electrode when a driving temperature inputted from the temperature sensor is more than said low temperature.

19. The driving apparatus as claimed in claim 17, wherein said switch controller turns on the switching device during the set-up interval when a driving temperature inputted from the temperature sensor is said low temperature.
